(19) United States
(12) Patent Application Publication
(10) Pub. No.: US 2014/0310324 A1
(43) Pub. Date: Oct. 16, 2014

(54) SYSTEMS AND METHODS FOR AUTOMATICALLY SORTING AND INDEXING ELECTRONIC FILES

(71) Applicant: APPSENSE LIMITED, Warrington (GB)

(72) Inventors: Paul Keith BRANTON, Rochdale (GB); Katherine PALLAS, Warrington (GB)

(73) Assignee: APPSENSE LIMITED, Warrington (GB)

(21) Appl. No.: 13/863,606

(22) Filed: Apr. 16, 2013

(51) Int. Cl. G06F 7/24; G06F 17/30

(52) U.S. Cl. CPC G06F 7/24; G06F 17/30123
USPC 707/830

(57) ABSTRACT

Systems and methods are provided for automatically sorting and indexing electronic files. A set of emails is received from a folder for an email program. A set of nouns from a first email from the set of emails is identified, wherein the first email comprises a document attached to the first email, and wherein the set of nouns are identified from the first email, the document attached to the first email, or both. The set of nouns are sorted alphabetically. A file structure is created on a storage device for storing data from the set of emails. The file structure includes a first folder with a same name as the folder for the email program, and a second folder with a name comprising the sorted set of nouns. The document attached to the first email is stored in the second folder.

### TECHNICAL FIELD

Embodiments of the invention generally relate to automatically sorting and indexing electronic files, and in particular automatically sorting and indexing emails and attachments.

### BACKGROUND

With the continual shift from paper-based communications to electronic communications as a primary means of communication, people are often faced with managing an ever-increasing number of emails (many of which include important attachments). This shift is occurring at both a consumer level and a business level. It is therefore common for users to create electronic filing systems to store important emails and/or attachments. However, organizing emails/attachments can take hours out of already-overwhelming schedules. Further, the number of emails received can be overwhelming, making it an often impossible task to organize and electronically file every email, let alone read each email. Therefore, it is not uncommon for emails and attachments to be lost in a sea of emails.

Many email clients support sub folders, which users can manually create and use to organize emails/attachments (e.g., sub-folders within the user's “Inbox”). Additionally email clients often support search and filter commands that allow users to search for emails by keyword, or to create rules that automatically filter received emails to a destination folder based on user-specified keywords. Users can also save attachments to disk and use the disk filing system to sort and filter the attachments. However, these solutions usually require a measure of user effort and time in sorting, prioritizing and filtering emails, thus making the process cumbersome and inefficient. Further, while a user can configure rules to sort emails to specified folders, the user must manually configure each rule.

Emails with attachments are inevitability larger than standard emails, and therefore are often the biggest contributor to the size of a user's inbox. There is often a limit on how much data can be stored in a user's email inbox (e.g., resource limitations for consumer email products, as well as email storage limitations imposed by businesses). Therefore users are often forced to archive entire folders, or to blindly delete stored data to comply with such restrictions. There can be a risk that important emails/attachments are accidentally deleted, or if a user's inbox is full then they may not be able to receive emails until other emails are deleted (e.g., to free up storage).

### SUMMARY

In accordance with the disclosed subject matter, systems, methods, and non-transitory computer-readable media are provided for automatically sorting, indexing, extracting and relocating emails to reduce the amount of data stored in a user's electronic inbox.

The disclosed subject matter includes a computerized method for sorting electronic files. The method includes receiving, by a computing device, a set of emails from a folder for an email program. The method includes identifying, by the computing device, a set of nouns from a first email from the set of emails, wherein the first email includes a document attached to the first email, and wherein the set of nouns are identified from (i) the first email, (ii) the document attached to the first email, or both. The method includes sorting, by the computing device, the set of nouns alphabetically. The method includes creating, by the computing device, a file structure on a storage device for storing data from the set of emails. The file structure includes a first folder with a same name as the folder for the email program, and a second folder with a name including the sorted set of nouns. The method includes storing, by the computing device, the document attached to the first email in the second folder.

The disclosed subject matter further includes a computing device for sorting electronic files. The server includes a database. The server also includes a processor in communication with the database, and configured to run a module stored in memory. The module stored in memory is configured to cause the processor to receive a set of emails from a folder for an email program. The module stored in memory is configured to cause the processor to identify a set of nouns from a first email from the set of emails, wherein the first email includes a document attached to the first email, and wherein the set of nouns are identified from (i) the first email, (ii) the document attached to the first email, or both. The module stored in memory is configured to cause the processor to sort the set of nouns alphabetically. The module stored in memory is configured to cause the processor to create a file structure on the database for storing data from the set of emails. The file structure includes a first folder with a same name as the folder for the email program, and a second folder with a name including the sorted set of nouns. The module stored in memory is configured to cause the processor to store the document attached to the first email in the second folder.

The disclosed subject matter further includes a non-transitory computer readable medium. The non-transitory computer readable medium has executable instructions operable to cause an apparatus to receive a set of emails from a folder for an email program. The instructions are further operable to cause an apparatus to identify a set of nouns from a first email from the set of emails, wherein the first email includes a document attached to the first email, and wherein the set of nouns are identified from (i) the first email, (ii) the document attached to the first email, or both. The instructions are further operable to cause an apparatus to sort the set of nouns alphabetically. The instructions are further operable to cause an apparatus to create a file structure on a storage device for storing data from the set of emails. The file structure includes a first folder with a same name as the folder for the email program, and a second folder with a name includes the sorted set of nouns. The instructions are further operable to cause an apparatus to store the document attached to the first email in the second folder.

The techniques described herein automatically sort, index and save to disk emails and/or attachments from an email inbox, or from other specified folders (e.g., located within the inbox). Once stored, the emails can then be removed from the inbox (or folder(s)) to free up space and to allow for better email management. A file structure can be created on a storage device that preserves the existing file structure of the inbox, and adds new folders with names that contain keywords extracted from the emails and/or attachments. The emails and/or attachments are then stored within the appropriate folder based on extracted keywords from the email and/or attachments. Attachments can be identified quicker based on the file structure (e.g., rather than blindly searching through large collections of emails). Automatically indexing and sorting the attachments can improve storage within the email system while providing a user with confidence that important emails and attachments were safely filed to disk for the backed-up folder. Additionally, a user can be sure to not miss important emails due to a lack of storage space within their mailbox.

These and other capabilities of the disclosed subject matter will be more fully understood after a review of the following figures, detailed description, and claims. It is to be understood that the phraseology and terminology employed herein are for the purpose of description and should not be regarded as limiting.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is an exemplary diagram of a system in accordance with some embodiments;

FIG. 2 is an exemplary diagram of a set of emails being automatically sorted and indexed, in accordance with some embodiments;

FIG. 3 is an exemplary diagram of a computerized method for automatically sorting and indexing electronic documents, in accordance with some embodiments;

FIG. 4 is an exemplary diagram of a set of emails within subfolders being automatically sorted and indexed, in accordance with some embodiments; and

FIG. 5 is an exemplary diagram of a graphical interface showing automatically sorted and indexed data, in accordance with some embodiments.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid unnecessary complication of the disclosed subject matter. In addition, it will be understood that the embodiments provided below are exemplary, and that it is contemplated that there are other systems and methods that are within the scope of the disclosed subject matter.

Rather than going through a time consuming manual sorting process of electronic data (e.g., emails and/or attachments), the disclosed techniques enable a user to perform a “one click” sorting and indexing of the data. The sorting and indexing results in a file structure stored in a local storage device that both preserves the original file structure and adds new folders within which to store the data based on keywords extracted from the data. The extracted keywords are used to create the new folders, within which emails and/or attachments with similar topics (or subject matter) are grouped.

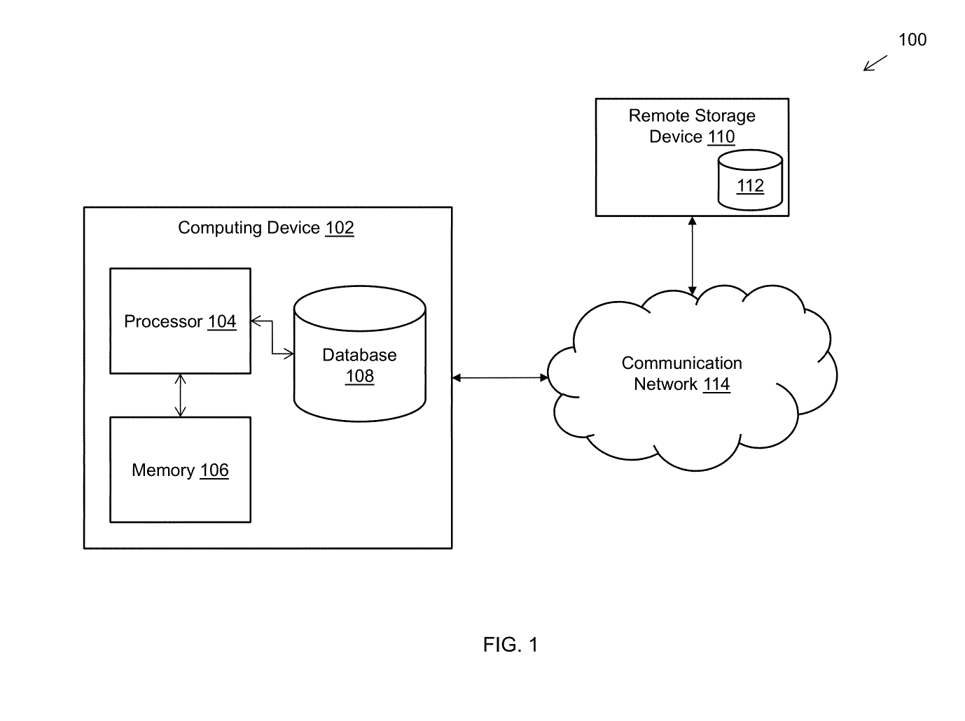

FIG. 1 is an exemplary diagram of a system 100 in accordance with some embodiments. System 100 includes computing device 102. The computing device can be, for example, a laptop, personal computer, mobile device, and/or the like. Computing device 102 includes processor 104, memory 106, and database 108. Processor 104 is in communication with memory 106 and database 108. The computing device 102 is in communication with remote storage device 104 through communication network 114. The computing device 104 includes local database 108. The computing device 102 can access and control data stored by the remote storage device 102 (e.g., in database 112).

The communication network 114 can include a network or combination of networks that can accommodate public or private data communication. For example, the communication network 114 can include a local area network (LAN), a cellular network, a telephone network, a computer network, a packet switching network, a line switching network, a wide area network (WAN), any number of networks that can be referred to as an Intranet, and/or the Internet. Such networks may be implemented with any number of hardware and software components, transmission media and network protocols. FIG. 1 shows the network 114 as a single network; however, the network 114 can include multiple interconnected networks listed above.

Processor 104 can be configured to implement the functionality described herein using computer executable instructions stored in a temporary and/or permanent non-transitory memory such as memory 106. Memory 106 can be flash memory, a magnetic disk drive, an optical drive, a programmable read-only memory (PROM), a read-only memory (ROM), or any other memory or combination of memories. The processor 104 can be a general purpose processor and/or can also be implemented using an application specific integrated circuit (ASIC), programmable logic array (PLA), field programmable gate array (FPGA), and/or any other integrated circuit. Similarly, databases 108 and 112 may also be flash memory, a magnetic disk drive, an optical drive, a programmable read-only memory (PROM), a read-only memory (ROM), or any other memory or combination of memories. The remote storage device 110 can execute an operating system that can be any operating system, including a typical operating system such as Windows, Windows XP, Windows 7, Windows 8, Windows Mobile, Windows Phone, Windows RT, Mac OS X, Linux, VXWorks, Android, Blackberry OS, iOS, Symbian, or other OSs. While not shown, the remote storage device 110 can include a processor and/or memory.

The components of system 100 can include interfaces (not shown) that can allow the components to communicate with each other and/or other components, such as other devices on one or more networks, server devices on the same or different networks, or user devices either directly or via intermediate networks. The interfaces can be implemented in hardware to send and receive signals from a variety of mediums, such as optical, copper, and wireless, and in a number of different protocols some of which may be non-transient.

The software in the computing device 102 and/or remote storage device 110 can be divided into a series of tasks that perform specific functions. These tasks can communicate with each other as desired to share control and data information throughout the computing device (e.g., via defined Application Programmer Interfaces (“APIs”)). A task can be a software process that performs a specific function related to system control or session processing. In some embodiments, three types of tasks can operate within the computing devices: critical tasks, controller tasks, and manager tasks. The critical tasks can control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem (as described below), and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem can be a software element that either performs a specific task or is a culmination of multiple other tasks. A single subsystem can include critical tasks, controller tasks, and manager tasks. Some of the subsystems that run on the computing device can include a system initiation task subsystem, a high availability task subsystem, a shared configuration task subsystem, and a resource management subsystem.

The system initiation task subsystem can be responsible for starting a set of initial tasks at system startup and providing individual tasks as needed. The high availability task subsystem can work in conjunction with the recovery control task subsystem to maintain the operational state of the computing device by monitoring the various software and hardware components of the computing device. Recovery control task subsystem can be responsible for executing a recovery action for failures that occur in the computing device and receives recovery actions from the high availability task subsystem. Processing tasks can be distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will preferably not be affected by that problem.

A shared configuration task subsystem can provide the computing device with an ability to set, retrieve, and receive notification of server configuration parameter changes and is responsible for storing configuration data for the applications running within the computing device. A resource management subsystem can be responsible for assigning resources (e.g., processor and memory capabilities) to tasks and for monitoring the task's use of the resources.

In some embodiments, the computing device can reside in a data center and form a node in a cloud computing infrastructure. The computing device can also provide services on demand such as Kerberos authentication, HTTP session establishment and other web services, and other services. A module hosting a client can be capable of migrating from one server to another server seamlessly, without causing program faults or system breakdown. A computing device in the cloud can be managed using a management system.

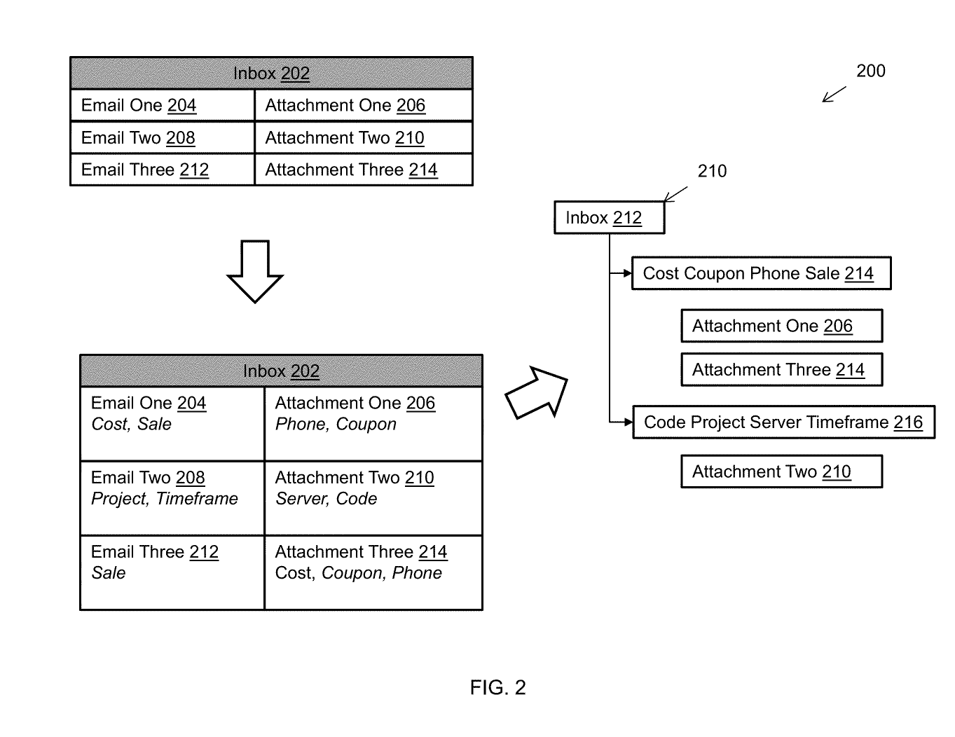

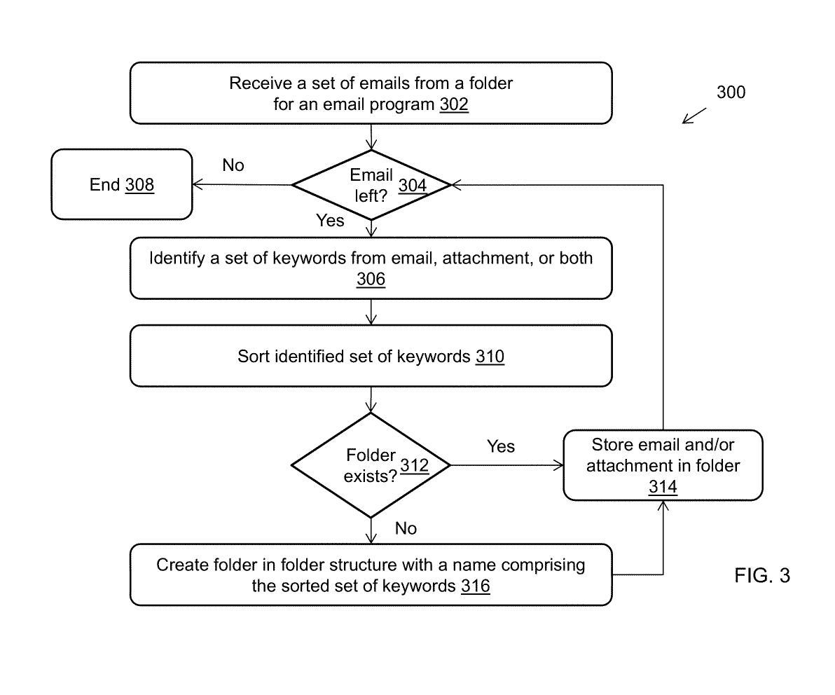

FIG. 2 is an exemplary diagram 200 of a set of emails being automatically sorted and indexed, in accordance with some embodiments. The inbox 202 includes three emails, each with an associated attachment: email one 204 that contains attachment one 206, email two 208 that contains attachment two 210, and email three 212 that contains attachment three 214. The computing device 102, e.g., via a keyword extraction program, extracts keywords from each email and its associated attachment for use in indexing them in a local file structure, which is further described below with reference to FIG. 3. As shown in FIG. 2, email one 204 contains keywords “cost” and “sale,” attachment 206 contains keywords “phone” and “coupon,” email two 208 contains the keywords “project” and “timeframe,” attachment two 210 contains the keywords “server” and “code,” email three 212 contains the keyword “sale,” and attachment three 214 contains the keywords and “cost,” “coupon” and “phone.”

As is further described below with reference to FIG. 3, the keywords are used to generate the file structure 210, which includes three folders: inbox folder 212 (e.g., which is identical to the inbox folder 202 from the email client), cost coupon phone sale folder 214, and code project server timeframe folder 216. The cost coupon phone sale folder 214 contains attachment one 206 and attachment three 214. The code project server timeframe folder 216 contains attachment two 210. Referring to FIG. 1, the inbox 202 and file structure 210 can be stored in the memory 106, the database 108, the remote storage device 110 (e.g., database 112), and/or the like. In some embodiments, the inbox 202 and the file structure 210 are stored on different storage devices (e.g., such that data can be archived using the file structure 210 to a separate storage device, and therefore deleted from the inbox 202 to free up space on the inbox 202 storage device). In some embodiments, the inbox 202 and the file structure 210 are stored on the same storage device, but use separate data structures (e.g., such that by removing data from the inbox 202 data structure reduces the data stored in the user's “Inbox,” while still backing up the removed data in the file structure 210).

FIG. 2 is for illustrative purposes only, and is not intended to be limiting. One of ordinary skill in the art can appreciate that the inbox 202 can include various features used in email clients that are known to one of skill of the art. For example, inbox 202 can include any number of emails, each of which may or may not include attachments. Further, the inbox 202 can include any number of sub-folders (and/or additionally nested sub-folders within the sub-folders), each of which can contain different sets of emails. Such a nested inbox structure was not shown for ease of explanation, but the file structure in the inbox can be preserved in the file structure 210, as is further described below.

Further, while a particular number of keywords are shown for each email and attachment (e.g., email one 204 has two identified keywords, and attachment one 206 has two identified keywords) any number of keywords can be identified for each email and/or attachment, as is further described below (e.g., based on identification criteria, such as relevance to both the email and attachment). For example, in some embodiments all of the keywords are identified from the attachment (e.g., and therefore none are identified from the email). In some embodiments, all of the keywords are identified from the email (e.g., and therefore none are identified from the attachment).

FIG. 3 is an exemplary diagram of a computerized method 300 for automatically sorting and indexing electronic documents, in accordance with some embodiments. Referring to FIG. 1, at step 302 the computing device 102 executes a program (e.g., via processor 104 and memory 106), that receives a set of emails from a folder for an email program. At step 304, the computing device 102 starts with the first email in the set of emails, and processes each email as described in the remaining steps of method 300. If the computing device 102 determines that there are still emails (e.g., and associated attachments) left to process from the set of emails, the computing device 102 proceeds to step 306. If the computing device 102 determines that there are no remaining emails to process, the computing device 102 proceeds to step 308 and ends method 300.

At step 306, the computing device 102 identifies a set of keywords from the email, the document attached to the email, or both. At step 310, the computing device 102 sorts the set of keywords (e.g., alphabetically). At step 312, the computing device 102 determines whether a folder exists in the file structure (e.g., stored on database 108 and/or database 112) with a name that matches (e.g., partially, or fully) the sorted set of keywords. If the folder does not exist, the method proceeds to step 316, otherwise the method proceeds to step 314. At step 314, the computing device 102 saves the email, attachment, or both in the identified folder. At step 316, the computing device 102 creates a folder that is named based on the sorted set of keywords. The method 300 proceeds to step 314, and the computing device 102 saves the email, attachment, or both in the newly created folder.

Referring to step 302, the emails can be accessed using an interface to the email client. For example, computing device 102 can use the messaging application programming interface (MAPI), which is a messaging architecture and a Component Object Model based application programmer interface for Microsoft Windows. Using an interface to the mail client can allow the computing device 102 to easily read the email client folder and attachments. In some embodiments, the computing device 102 accesses local data (e.g., stored within the computing device 102 itself) to obtain the emails.

Referring further to step 302, the emails can be from a particular folder in the user's mail client (e.g., the user's “Inbox”, a sub-folder from the “Inbox,” and/or the like). The data received can include information indicative of a file structure within the email program folder. For example, the file structure can include the user's “Inbox” as the top level folder in the file structure, and can also include a number of additional sub-folders (and/or nested sub-folders) within the user's “Inbox,” each of which may include associated emails. In some embodiments, the folder is stored in memory 106 and/or database 108. A user can specify the folder, or set of folders, for the computing device 102 to sort and index (e.g., via a graphical user interface). In some embodiments, the program can receive the set of emails from the remote storage device 110 (e.g., if a user is using a web-based email client).

Referring to step 304, each email is processed by the method 300 until all emails are processed. For example, referring to FIG. 2, the computing device 102 processes email one 204, which includes attachment one 206. The computing device 102 extracts the keywords “cost, sale, phone, coupon” from email one 204 and attachment one 206, and alphabetically sorts the keywords to “cost, coupon, phone, sale.” Since email one 204 was in the inbox 202, the computing device searches for a folder named “cost coupon phone sale” in the inbox folder 212 in the file structure 410. Since it does not find the folder, it creates the cost coupon phone sale folder 214 as a sub-folder of the inbox 212. The computing device stores the attachment one 206 in the cost coupon phone sale folder 214.

The computing device 102 next processes email two 208 and attachment two 210. The computing device 102 extracts keywords “project, timeframe, server, code,” and alphabetically sorts the keywords to “code, project, server, timeframe.” Since email two 208 was in the inbox 202, the computing device searches for a folder named “code project server timeframe” in the inbox folder 212. Since the computing device does not find the folder, the computing device creates the code project server timeframe folder 216 as a sub-folder of the inbox folder 212. The computing device stores the attachment two 210 in the code project server timeframe folder 216.

The computing device 102 next processes email three 212 and attachment three 214. The computing device 102 extracts keywords “cost, sale, phone, coupon,” and alphabetically sorts the keywords to “cost, coupon, phone, sale.” Since email three 212 was in the inbox folder 202, the computing device searches for a folder named “cost coupon phone sale” in the inbox folder 212. The computing device 102 identifies cost coupon phone sale folder 214, and stores the attachment three 214 in the cost coupon phone sale folder 408.

Referring further to step 304, in some embodiments the method 300 is configured to only process an email if it has an attachment. Therefore, in some embodiments step 304 checks whether the email from the set of emails includes an attachment. If the email includes an attachment, the method proceeds to step 306. If the email does not include an attachment, step 304 can proceed to analyze remaining emails (e.g., until no emails are left, at which point method 300 proceeds to step 308 and terminates).

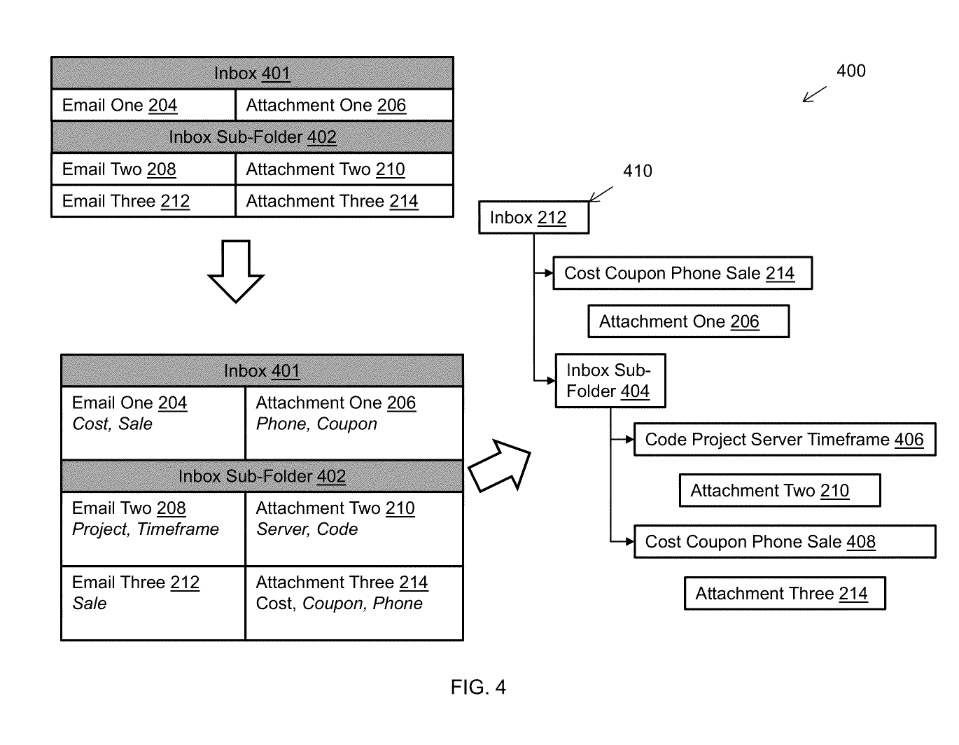

Referring further to step 304, the computing device 102 can process emails in sub-folders within the email program folder in a recursive manner. For example, the data received in step 302 can include data indicative of a set of sub-folders in the folder for the email program, as described with reference to step 302. In some embodiments, the method 300 can be configured to search for folders only within a parent folder of the file structure that has a same name as the sub-folder in the email program folder that contained the email. For example, FIG. 4 is an exemplary diagram 400 of a set of emails within sub-folders being automatically sorted and indexed, in accordance with some embodiments. Similar to FIG. 2, the inbox 401 includes three emails, each with an associated attachment: email one 204 that contains attachment one 206, email two 208 that contains attachment two 210, and email three 212 that contains attachment three 214. But unlike in FIG. 2, email two 208 (with attachment two 210) and email three 212 (with attachment three 214) are within the inbox sub-folder 402 within the inbox folder 401.

The file structure 410 differs from the file structure 210 of FIG. 2. As shown in FIG. 4, the file structure of inbox 401 is first copied to the file structure 410. As a result, the file structure 410 includes the base folders inbox 212 (e.g., which is named based on (e.g., identical to) the inbox folder 401) as well as inbox sub-folder 404 (e.g., which is named based on (e.g., identical to) the inbox sub-folder 402). The keywords are used to generate the remaining folders in the file structure 410, which includes: (a) cost coupon phone sale folder 214, which is a sub-folder of inbox 212 (like with FIG. 2), (b) code project server timeframe folder 406, which is a sub-folder of the inbox sub-folder 404, and (c) cost coupon phone sale 408, which is also a sub-folder of the inbox sub-folder 404.

Referring to email one 404, the computing device 102 extracts the keywords “cost, sale, phone, coupon” from email one 204 and attachment one 206, and alphabetically sorts the keywords to “cost, coupon, phone, sale.” Since email one 204 was in the inbox 401, the computing device searches for a folder named “cost coupon phone sale” in the inbox folder 212 in the file structure 410. Since it does not find the folder, it creates the cost coupon phone sale folder 214 as a sub-folder of the inbox 212. The computing device stores the attachment one 206 in the cost coupon phone sale folder 214.

The computing device 102 next processes email two 208 and attachment two 210. The computing device 102 extracts keywords “project, timeframe, server, code,” and alphabetically sorts the keywords to “code, project, server, timeframe.” Since email two 208 was in the inbox sub-folder 402, the computing device 102 searches for a folder named “code project server timeframe” in the inbox sub-folder 404. Since it does not find the folder, it creates the code project server timeframe folder 406 as a sub-folder of the inbox sub-folder 404. The computing device stores the attachment two 210 in the code project server timeframe folder 406.

The computing device 102 next processes email three 212 and attachment three 214. The computing device 102 extracts keywords “cost, sale, phone, coupon,” and alphabetically sorts the keywords to “cost, coupon, phone, sale.” Since email three 212 was in the inbox sub-folder 402, the computing device searches for a folder named “cost coupon phone sale” in the inbox sub-folder 404. Since it does not find the folder, it creates the cost coupon phone sale folder 408 as a sub-folder of the inbox sub-folder 404. The computing device stores the attachment three 214 in the cost coupon phone sale folder 408. Note that even though there is a the cost coupon phone sale folder 214 exists in the inbox 212 (e.g., and therefore has a name that includes the keywords identified from email three 212 and attachment three 214), in this example since email three 212 was in inbox sub-folder 402, only the corresponding inbox sub-folder 404 is searched for a folder containing the identified keywords.

Referring to step 306, the number of keywords the computing device 102 identifies can be configurable (e.g., four keywords, five keywords, and/or the like). Further, the type of keyword can be configurable (e.g., nouns, adjectives, etc.). In some embodiments, the keywords can be a preconfigured number of nouns extracted from the email and/or attachment. The computing device 102 can identify each keyword based on a number of times each keyword appears in the email and/or attachment (e.g., by selecting a predetermined number of keywords that have the highest word counts). For example, U.S. patent application Ser. No. 13/763,864, entitled “Document Summarization Using Noun and Sentence Ranking,” filed on Feb. 11, 2013, which is hereby incorporated by reference herein in its entirety, generally describes methods of summarizing documents by identifying the most prevalent nouns. The summarization techniques described therein can be used to extract a set of nouns from the emails and attachments. Other techniques can be used to extract the keywords, such as identifying a preconfigured number of the most prevalent words (e.g., excluding articles, etc.), identifying words that are in both the email title and the body of the attachment, and/or other identification techniques.

The computing device 102 can extract the keywords from the email, from the attachment, or from a combination of both. In some embodiments, the keywords are extracted from the body of the attachment. In some embodiments, the keywords are extracted from the title of the email, the body of the email, and/or other portions of the email (e.g., email addresses, etc.). In some embodiments, the keywords are extracted from both the email and the attachment.

Referring to step 310, the computing device 102 can sort the keywords alphabetically, reverse-alphabetically, and/or the like. The computing device can also sort the keywords using other techniques, such as based on the type of word (e.g., such as nouns, verbs, etc.), based on the prevalence of the keyword in the email/attachment, and/or the like. In some embodiments, the computing device 102 sorts the identified keywords in the same manner for each identified set to ensure that multiple folders are not made for the same keywords (e.g., a first folder with keywords in a first order, and a second folder with the same keywords in a different order).

Referring to step 312, the computing device 102 first creates a base file structure on a storage device for storing data from the set of emails. The file structure mirrors that of the email folder and any sub-folders on the email client. Referring to FIG. 2, for example, the inbox 202 folder is the only folder, and therefore the file structure 210 begins with creating inbox folder 212 (e.g., based on the name of the inbox folder 202). Referring to FIG. 4, for example, the inbox 202 includes inbox sub-folder 402, so the base file structure 410 includes inbox folder 212 and inbox sub-folder 404 nested within the inbox folder 212.

Referring to step 316, the computing device 102 can be configured to create each new folder within the corresponding folder in the email system that housed the email. The computing device 102 can be configured to not store files in the inbox root folder (e.g., inbox 212 of file structure 210 in FIG. 2), but instead within sub-folders created based on extracted keywords (e.g., folders 214 and 216 of FIG. 2). For example, referring to FIG. 4, the cost coupon phone sale folder 214 is created as a sub-folder to the inbox 212 for attachment one 206, because email one 204 and attachment one 206 are within inbox 401. As another example, cost coupon phone sale folder 408 is created as a sub-folder to the inbox sub-folder 404 for attachment three 214, because email three 212 and attachment three 214 are within inbox sub-folder 402.

Referring further to step 316, the folders can be named in any manner such that the computing device 102 can identify the folder and use it to store attachments that have the same set of identified keywords. In some embodiments, the folder names can contain the identified, sorted keywords. For example, the folder names can include just the keywords (e.g., as shown in FIGS. 2 and 4). In some examples, the folder names can include concatenated keywords (e.g., no spaces, such as “costcouponphonesale” for folder 214 in FIG. 2). In some examples, the keywords can be separate by additional characters that are proper characters for a file name (e.g., “_”, “.”, and/or the like). Additionally, the folders can include additional text without departing from the spirit of the techniques disclosed herein (e.g., a date stamp of first creation, etc.). As another example, the folders can include a value derived from a set of sorted keywords in addition to, or in place of, some or all of the keywords (e.g., a hash, a summary keyword, etc.).

Referring to step 314, the computing device can store the email, the attachment, or both in the identified (or created) folder. Referring to FIGS. 2 and 4, the computing device 102 stores the attachments within the created (or identified) folders. In some embodiments, the computing device also stores emails (e.g., in addition to, or in place of, the attachments). For example, referring to FIG. 2, the computing device 102 can also store email one 204 in cost coupon phone sale folder 214 in addition to the attachment one 206. In some examples, if the email does not include an attachment, the computing device 102 can process the email (e.g., using method 300 of FIG. 3) and store the email in its appropriate folder (e.g., by storing the body of the email).

Referring further to step 314, the computing device 102 can be configured to name the files (e.g., the emails and/or attachments) according to a naming convention. For example, the computing device 102 can name an email using the subject of the email, using keywords extracted from various fields of the email, etc. As another example, the computing device 102 can name the attachment based on the attachment name, keywords extracted from the attachment, etc. The computing device 102 can resolve identical names using standard techniques. For example, if the computing device 102 determines that the filename already exists, the computing device 102 can create a new file with a “copy” suffix added to filename portion. If the computing device 102 determines that the “copy” suffix already exists, the computing device 102 can append a number after the “copy” suffix, and continue to increase the number until no filename exists with the same filename. For example, if the computing device 102 is creating “The Document.docx” but determines “The Document.docx” exists, then the computing device 102 names the file “The Document Copy.docx.”

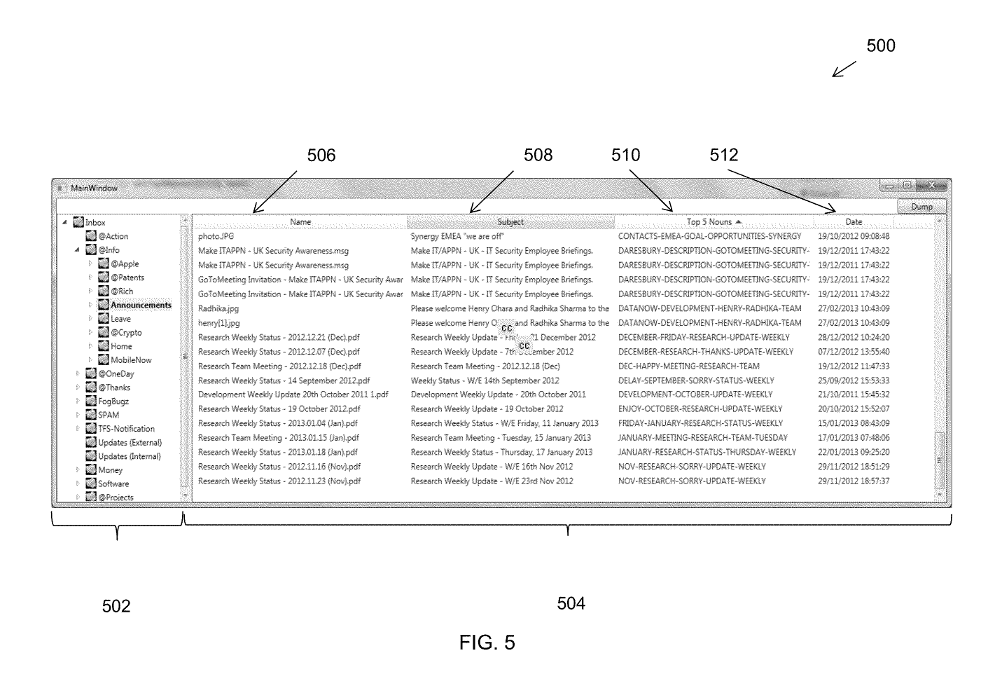

FIG. 5 is an exemplary diagram of a graphical interface 500 showing automatically sorted and indexed data, in accordance with some embodiments. The graphical interface 500 include a tree view 502 and a list view 504. The tree view 502 shows a hierarchical view of an inbox folder structure. The list view 504 includes four columns for each item within the selected folder “Announcements” from the tree view 502: name column 506, subject column 508, top five nouns column 510, and date column 512. Name column 506 shows the name of the file (e.g., the name for the attachment or the email body), subject column 508 shows the subject of the email that contained the file (e.g., which can show which emails are being grouped together), top five nouns column 510 shows the top five nouns (e.g., keywords) for a suggested sub-folder (e.g., identified for the file), and date column 512 shows the date the file was created in the folder structure.

In some embodiments, the computing device 102 can be configured to remove a processed (e.g., archived) email and/or its associated attachment from the email client folder. For example, referring to FIG. 2, after the computing device 102 stores attachment one 206 in the cost coupon phone sale folder 214 (e.g., where the file structure 210 resides on a different storage device than inbox 202, or within a different data structure than the inbox 202), the computing device 102 can remove attachment one 206 from inbox 202, remove email one 204 from the inbox 202, or remove both from the inbox 202. This can automatically free up space within the user's Inbox folder. In some embodiments, the computing device 102 can be configured to move a processed (e.g., archived) email and/or its associated attachment from the email client folder to a separate folder (e.g., a separate folder identified by a user).

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A computerized method for sorting electronic files, the method comprising:
receiving, by a computing device, a set of emails from a folder for an email program;
identifying, by the computing device, a set of nouns from a first email from the set of emails, wherein the first email comprises a document attached to the first email, and wherein the set of nouns are identified from (i) the first email, (ii) the document attached to the first email, or both;
sorting, by the computing device, the set of nouns alphabetically;
creating, by the computing device, a file structure on a storage device for storing data from the set of emails, the file structure comprising:
a first folder with a same name as the folder for the email program; and
a second folder with a name comprising the sorted set of nouns; and
storing, by the computing device, the document attached to the first email in the second folder.

2. The method of claim 1, further comprising:
identifying a second set of nouns from (i) a second email from the set of emails, (ii) a second document attached to the second email, or both; and
sorting the second set of nouns alphabetically.

3. The method of claim 2, further comprising:
identifying a folder in the file structure with a name comprising the sorted second set of nouns; and
storing the second document, the second email, or both, in the identified folder.

4. The method of claim 2, further comprising:
determining that no folders in the file structure have a name that comprises the sorted second set of nouns;
creating a third folder in the file structure with a name comprising the second set of sorted nouns; and
storing the second document attached to the second email, the second email, or both, in the third folder.

5. The method of claim 1 further comprising storing the first email in the second folder.

6. The method of claim 1 further comprising identifying the set of nouns based on a number of times each noun in the set of nouns appears in the first email, the document attached to the first email, or both.

7. The method of claim 1, further comprising removing the first email, the document attached to the first email, or both, from the folder for the email program.

8. The method of claim 1, further comprising:
receiving data indicative of a set of sub-folders in the folder for the email program; and
for each sub-folder in the set of sub-folders, creating a new folder in the file structure, where the new folder has a same name as that of the corresponding sub-folder.

9. The method of claim 8, further comprising:
identifying a second set of nouns from (i) a second email from a second set of emails in a sub-folder in the set of sub-folders, (ii) a second document attached to the second email, or both; and
sorting the second set of nouns alphabetically.

10. The method of claim 9, further comprising:
identifying a folder in the file structure with a name comprising the sorted second set of nouns, wherein the identified folder is located under a parent folder in the file structure, where the parent folder has a same name as the sub-folder containing the second email; and
storing the second document, the second email, or both, in the identified folder.

11. The method of claim 9, further comprising:
determining that no folders in the file structure have a name that comprises the sorted second set of nouns;
creating a third folder in the file structure with a name comprising the second set of sorted nouns, wherein the third folder is created under a parent folder in the file structure, where the parent folder has a same name as the sub-folder containing the second email; and
storing the second document attached to the second email, the second email, or both, in the third folder.

12. A computing device for sorting electronic files, the server comprising:
a database; and
a processor in communication with the database, and configured to run a module stored in memory that is configured to cause the processor to:
receive a set of emails from a folder for an email program;
identify a set of nouns from a first email from the set of emails, wherein the first email comprises a document attached to the first email, and wherein the set of nouns are identified from (i) the first email, (ii) the document attached to the first email, or both;
sort the set of nouns alphabetically;
create a file structure on the database for storing data from the set of emails, the file structure comprising:
a first folder with a same name as the folder for the email program; and
a second folder with a name comprising the sorted set of nouns; and
store the document attached to the first email in the second folder.

13. The computing device of claim 12, wherein the module stored in memory is further configured to cause the processor to:
identify a second set of nouns from (i) a second email from the set of emails, (ii) a second document attached to the second email, or both; and
sort the second set of nouns alphabetically.

14. The computing device of claim 13, wherein the module stored in memory is further configured to cause the processor to:
identify a folder in the file structure with a name comprising the sorted second set of nouns; and
store the second document, the second email, or both, in the identified folder.

15. The computing device of claim 13, wherein the module stored in memory is further configured to cause the processor to:
determine that no folders in the file structure have a name that comprises the sorted second set of nouns;
create a third folder in the file structure with a name comprising the second set of sorted nouns; and
store the second document attached to the second email, the second email, or both, in the third folder.

16. The computing device of claim 12, wherein the module stored in memory is further configured to cause the processor to:
receive data indicative of a set of sub-folders in the folder for the email program; and
for each sub-folder in the set of sub-folders, create a new folder in the file structure, where the new folder has a same name as that of the corresponding sub-folder.

17. The computing device of claim 16, wherein the module stored in memory is further configured to cause the processor to:
identify a second set of nouns from (i) a second email from a second set of emails in a sub-folder in the set of sub-folders, (ii) a second document attached to the second email, or both; and
sort the second set of nouns alphabetically.

18. The computing device of claim 17, wherein the module stored in memory is further configured to cause the processor to:
identify a folder in the file structure with a name comprising the sorted second set of nouns, wherein the identified folder is located under a parent folder in the file structure, where the parent folder has a same name as the sub-folder containing the second email; and
store the second document, the second email, or both, in the identified folder.

19. The computing device of claim 18, wherein the module stored in memory is further configured to cause the processor to:
determine that no folders in the file structure have a name that comprises the sorted second set of nouns;
create a third folder in the file structure with a name comprising the second set of sorted nouns, wherein the third folder is created under a parent folder in the file structure, where the parent folder has a same name as the sub-folder containing the second email; and
store the second document attached to the second email, the second email, or both, in the third folder.

20. A non-transitory computer readable medium having executable instructions operable to cause an apparatus to:
receive a set of emails from a folder for an email program;
identify a set of nouns from a first email from the set of emails, wherein the first email comprises a document attached to the first email, and wherein the set of nouns are identified from (i) the first email, (ii) the document attached to the first email, or both;
sort the set of nouns alphabetically;
create a file structure on a storage device for storing data from the set of emails, the file structure comprising:
a first folder with a same name as the folder for the email program; and
a second folder with a name comprising the sorted set of nouns; and
store the document attached to the first email in the second folder.
